(19) United States
(12) Patent Application Publication
(10) Pub. No.: US 2013/0193686 A1
(43) Pub. Date: Aug. 1, 2013

(54) SYSTEM AND METHODS FOR DETERMINING PITCH ANGLES FOR A WIND TURBINE DURING PEAK SHAVING

(71) Applicants: Thomas Franklin Perley, Simpsonville, SC (US); Bruce Clark Busbey, Greer, SC (US); Brandon Shane Gerber, Charleston, SC (US)

(72) Inventors: Thomas Franklin Perley, Simpsonville, SC (US); Bruce Clark Busbey, Greer, SC (US); Brandon Shane Gerber, Charleston, SC (US)

(73) Assignee: GENERAL ELECTRIC COMPANY, Schenectady, NY (US)

(21) Appl. No.: 13/359,837

(22) Filed: Jan. 27, 2012

(51) Int. Cl. H02P 9/04

(52) U.S. Cl. 290/44

(57) ABSTRACT

A method for determining pitch angles for at least one rotor blade of a wind turbine during peak shaving is disclosed. The method may generally include receiving a signal with a controller associated with a peak shaving parameter of the wind turbine and determining a target pitch angle for the at least one rotor blade based on a mathematical relationship between the target pitch angle and the peak shaving parameter, wherein the mathematical relationship is modeled as a non-linear function.

### FIELD OF THE INVENTION

The present subject matter relates generally to wind turbines and, more particularly, to a system and methods for determining the pitch angles for wind turbine rotor blades during peak shaving in order to reduce loads while minimizing power losses.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades are the primary elements for converting wind energy into electrical energy. The blades typically have the cross-sectional profile of an airfoil such that, during operation, air flows over the blade producing a pressure difference between the sides. Consequently, a lift force, which is directed from the pressure side towards the suction side, acts on the blade. The lift force generates torque on the main rotor shaft, which is geared to a generator for producing electricity.

At wind speeds below the rated wind speed of a wind turbine (i.e., the wind speed at which a wind turbine can achieve its rated power), the pitch angle of the rotor blades is typically maintained at the power position in order to capture the maximum amount of energy from the wind. However, as wind speeds reach and exceed the rated wind speed, the pitch angle must be adjusted towards feather to maintain the power output of the wind turbine at its rated power, thereby preventing components of the turbine, such as electrical components, from being damaged. Thus, the aerodynamic loads acting on the rotor blades continually increase with increasing wind speeds while the pitch angle of the rotor blades is maintained at the power position (i.e., until the rated wind speed is achieved) and then begin to decrease as the pitch angle is adjusted towards feather with wind speeds above the rated wind speed. Such control of the wind turbine typically creates a peak in the aerodynamic loading on a wind turbine at its rated wind speed. For example, FIG. 1 illustrates a graph of wind speed (x-axis) versus loads (y-axis) for a typical wind turbine. As shown, aerodynamic loads on the wind turbine increase to a peak 10 at the rated wind speed (indicated by line 12) and then decrease as the rotor blades are pitched toward feather in order to maintain the wind turbine at its rated power.

To prevent the formation of such a peak 10, peak shaving control methods are known that may be used to reduce the loads on a wind turbine at or near the rated wind speed. In particular, these control methods typically begin to adjust the pitch angle of the rotor blades at some point prior to the rated wind speed. For example, as shown in FIG. 1, by adjusting the pitch angle of the rotor blades towards feather prior to reaching the rated wind speed (line 12), the loads acting on the rotor blade at or near the rated wind speed may be reduced. Specifically, as shown in FIG. 1, the use of a peak shaving control method may create a peak shaving range 14 within the graph at which loads are reduced along a range of wind speed values. However, such a control method also results in a reduction in the overall efficiency of the wind turbine, as power production at or near the rated wind speed is sacrificed (i.e., by prematurely pitching the rotor blades) in order to reduce wind loads.

Conventional peak shaving control methods, such as the one illustrated in FIG. 1, rely on a linear relationship between power output and pitch angle to make pitch angle adjustments within the peak shaving range 14. For example, many peak shaving control methods are designed to make pitch angle adjustments using the equation y=Ax+B, wherein y corresponds to the pitch angle of the rotor blades, x corresponds to the power output of the wind turbine and A and B correspond to predetermined constants. While such linear peak shaving control methods are useful for reducing the loads at or near the rated wind speed, they also result in significant power losses within the peak shaving range 14. Specifically, the rate of change in which the loads acting on a wind turbine are adjusted within the peak shaving region 14 is relatively slow, which is characterized in graph by the rounded-off, curved section 16 within the peak shaving range 14). This slow rate of change results in significant power losses, as it takes longer for the wind turbine to achieve its rated power as the pitch angle is adjusted during peak shaving.

Accordingly, an improved system and/or peak shaving control method that provides for sufficient load reduction while minimizing power losses would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a method for determining pitch angles for at least one rotor blade of a wind turbine during peak shaving. The method may generally include receiving a signal with a controller associated with a peak shaving parameter of the wind turbine and determining a target pitch angle for the at least one rotor blade based on a mathematical relationship between the target pitch angle and the peak shaving parameter, wherein the mathematical relationship is modeled as a non-linear function.

In another aspect, the present subject matter discloses a system for determining pitch angles for at least one rotor blade of a wind turbine during peak shaving. The system may generally include a sensor configured to monitor a peak shaving parameter of the wind turbine and a controller communicatively coupled to the sensor. The controller may be configured to determine a target pitch angle for the at least one rotor blade based on a mathematical relationship between the target pitch angle and the peak shaving parameter, wherein the mathematical relationship is modeled as a non-linear function.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates one embodiment of a graph of wind speed (x-axis) versus loads (y-axis) for a typical wind turbine, particularly illustrating the use of a conventional linear peak shaving method to reduce loads on the wind turbine;

FIG. 2 illustrates a perspective view of one embodiment of a wind turbine;

FIG. 3 illustrates perspective, internal view of one embodiment of a nacelle of a wind turbine;

FIG. 4 illustrates a schematic diagram of one embodiment of a turbine controller of a wind turbine;

FIG. 5 illustrates a flow diagram of one embodiment of a method for determining pitch angles for a wind turbine during peak shaving;

FIG. 6 illustrates one embodiment of a graph of wind speed (x-axis) versus loads (y-axis) for a typical wind turbine, particularly illustrating the use of both a conventional linear peak shaving method and the disclosed peak shaving method; and

FIG. 7 illustrates one embodiment of a graph of wind speed (x-axis) versus power output (y-axis) for a typical wind turbine, particularly illustrating the use of both a conventional linear peak shaving method and the disclosed peak shaving method.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and methods for operating a wind turbine in order to reduce loads while minimizing power losses. Specifically, the present subject matter discloses a peak shaving control method that provides for reduced loads at or near the rated wind speed of a wind turbine while exhibiting less power losses than that of a conventional linear peak shaving method. For example, in several embodiments, the relationship between the pitch angle for the rotor blades and a peak shaving parameter of the wind turbine (e.g., power output, loads and/or the like) may be modeled as a non-linear function, such as a second order or higher polynomial function. It has been found by the present inventors that the use of such a non-linear relationship to determine the target pitch angles during peak shaving allows for the same or even better load reduction than linear peak shaving methods while providing a substantially increased power output over such conventional methods.

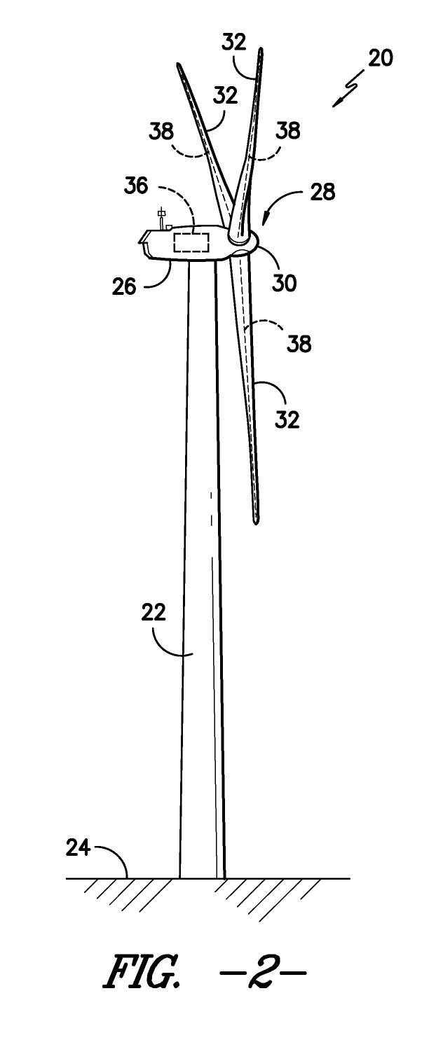

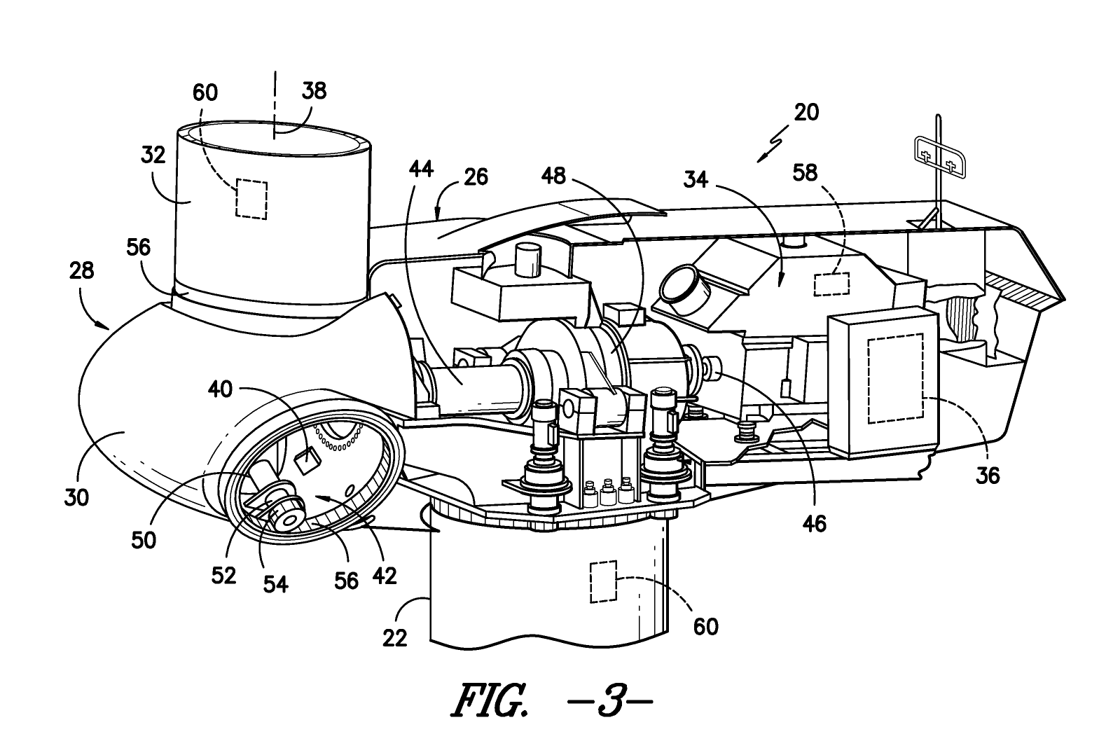

Referring now to FIG. 2, a perspective view of one embodiment of a wind turbine 20 is illustrated. As shown, the wind turbine 20 generally includes a tower 22 extending from a support surface 24, a nacelle 26 mounted on the tower 22, and a rotor 28 coupled to the nacelle 26. The rotor 28 includes a rotatable hub 30 and at least one rotor blade 32 coupled to and extending outwardly from the hub 30. For example, in the illustrated embodiment, the rotor 28 includes three rotor blades 32. However, in an alternative embodiment, the rotor 28 may include more or less than three rotor blades 32. Each rotor blade 32 may be spaced about the hub 30 to facilitate rotating the rotor 28 to enable kinetic energy to be transferred from the wind into usable mechanical energy, and subsequently, electrical energy. For instance, the hub 30 may be rotatably coupled to an electric generator 34 (FIG. 3) positioned within the nacelle 26 to permit electrical energy to be produced.

The wind turbine 10 may also include a turbine control system or turbine controller 36 centralized within the nacelle 26. In general, the turbine controller 36 may comprise a computer or other suitable processing unit. Thus, in several embodiments, the turbine controller 36 may include suitable computer-readable instructions that, when implemented, configure the controller 36 to perform various different functions, such as receiving, transmitting and/or executing wind turbine control signals. As such, the turbine controller 36 may generally be configured to control the various operating modes (e.g., start-up or shut-down sequences) and/or components of the wind turbine 20. For example, the controller 36 may be configured to adjust the blade pitch or pitch angle of each rotor blade 22 (i.e., an angle that determines a perspective of the blade 22 with respect to the direction of the wind) about its pitch axis 38 in order to control the rotational speed of the rotor blade 32 and/or the power output generated by the wind turbine 20. For instance, the turbine controller 36 may control the pitch angle of the rotor blades 32, either individually or simultaneously, by transmitting suitable control signals directly or indirectly (e.g., via a pitch controller 40 (FIG. 3)) to one or more pitch adjustment mechanisms 42 (FIG. 3) of the wind turbine 10. During operation of the wind turbine 20, the controller 36 may generally control each pitch adjust mechanism 42 in order to alter the pitch angle of each rotor blade 30 between 0 degrees (i.e., a power position of the rotor blade 30) and 90 degrees (i.e., a feathered position of the rotor blade 30).

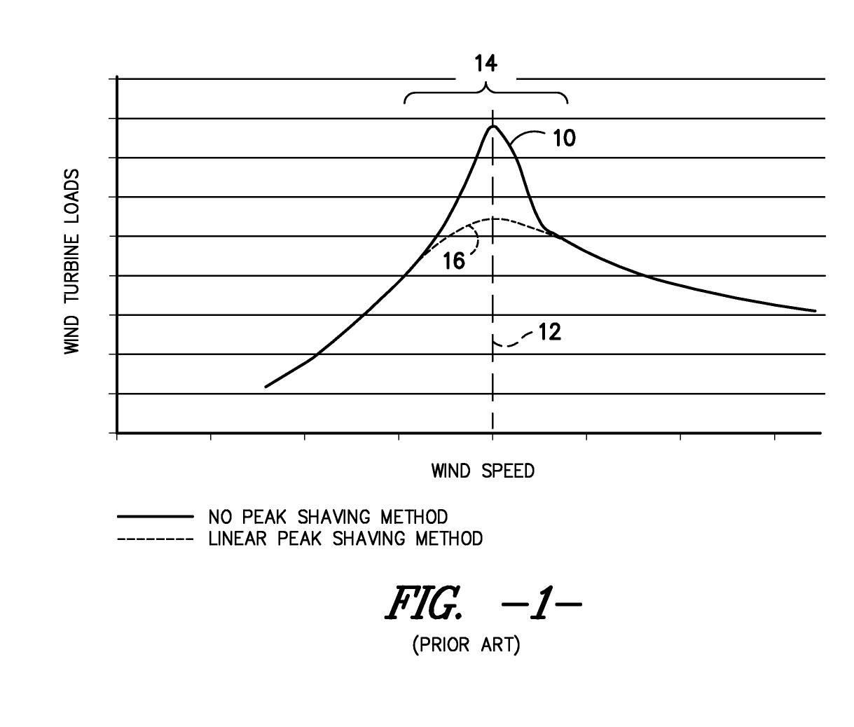

Referring now to FIG. 3, a simplified, internal view of one embodiment of the nacelle 26 of the wind turbine 20 shown in FIG. 1 is illustrated. As shown, a generator 34 may be disposed within the nacelle 26. In general, the generator 34 may be coupled to the rotor 28 for producing electrical power from the rotational energy generated by the rotor 28. For example, as shown in the illustrated embodiment, the rotor 28 may include a rotor shaft 44 coupled to the hub 30 for rotation therewith. The rotor shaft 44 may, in turn, be rotatably coupled to a generator shaft 46 of the generator 34 through a gearbox 48. As is generally understood, the rotor shaft 44 may provide a low speed, high torque input to the gearbox 48 in response to rotation of the rotor blades 32 and the hub 30. The gearbox 48 may then be configured to convert the low speed, high torque input to a high speed, low torque output to drive the generator shaft 46 and, thus, the generator 34.

Additionally, the turbine controller 36 may also be located within the nacelle 26. As is generally understood, the turbine controller 36 may be communicatively coupled to any number of the components of the wind turbine 20 in order to control the operation of such components. For example, as indicated above, the turbine controller 36 may be communicatively coupled to each pitch adjustment mechanism 42 of the wind turbine 20 (one of which is shown) via a pitch controller 40 to facilitate rotation of each rotor blade 32 about its pitch axis 38.

In general, each pitch adjustment mechanism 42 may include any suitable components and may have any suitable configuration that allows the pitch adjustment mechanism 42 to function as described herein. For example, in several embodiments, each pitch adjustment mechanism 42 may include a pitch drive motor 50 (e.g., any suitable electric motor), a pitch drive gearbox 52, and a pitch drive pinion 54. In such embodiments, the pitch drive motor 50 may be coupled to the pitch drive gearbox 52 so that the pitch drive motor 50 imparts mechanical force to the pitch drive gearbox 52. Similarly, the pitch drive gearbox 52 may be coupled to the pitch drive pinion 54 for rotation therewith. The pitch drive pinion 54 may, in turn, be in rotational engagement with a pitch bearing 56 coupled between the hub 30 and a corresponding rotor blade 32 such that rotation of the pitch drive pinion 54 causes rotation of the pitch bearing 56. Thus, in such embodiments, rotation of the pitch drive motor 50 drives the pitch drive gearbox 52 and the pitch drive pinion 54, thereby rotating the pitch bearing 56 and the rotor blade 32 about the pitch axis 38.

In alternative embodiments, it should be appreciated that each pitch adjustment mechanism 42 may have any other suitable configuration that facilitates rotation of a rotor blade 32 about its pitch axis 28. For instance, pitch adjustment mechanisms 42 are known that include a hydraulic or pneumatic driven device (e.g., a hydraulic or pneumatic cylinder) configured to transmit rotational energy to the pitch bearing 56, thereby causing the rotor blade 32 to rotate about its pitch axis 38. Thus, in several embodiments, instead of the electric pitch drive motor 50 described above, each pitch adjustment mechanism 42 may include a hydraulic or pneumatic driven device that utilizes fluid pressure to apply torque to the pitch bearing 56.

Referring still to FIG. 3, the wind turbine 20 may also include a plurality of sensors 58, 60 for monitoring one or more parameters and/or conditions of the wind turbine 20. As used herein, a parameter or condition of the wind turbine 20 is “monitored” when a sensor 58, 60 is used to determine its present value. Thus, the term “monitor” and variations thereof are used to indicate that the sensors 58, 60 need not provide a direct measurement of the parameter and/or condition being monitored. For example, the sensors 58, 60 may be used to generate signals relating to the parameter and/or condition being monitored, which can then be utilized by the turbine controller 36 or other suitable device to determine the actual parameter and/or condition.

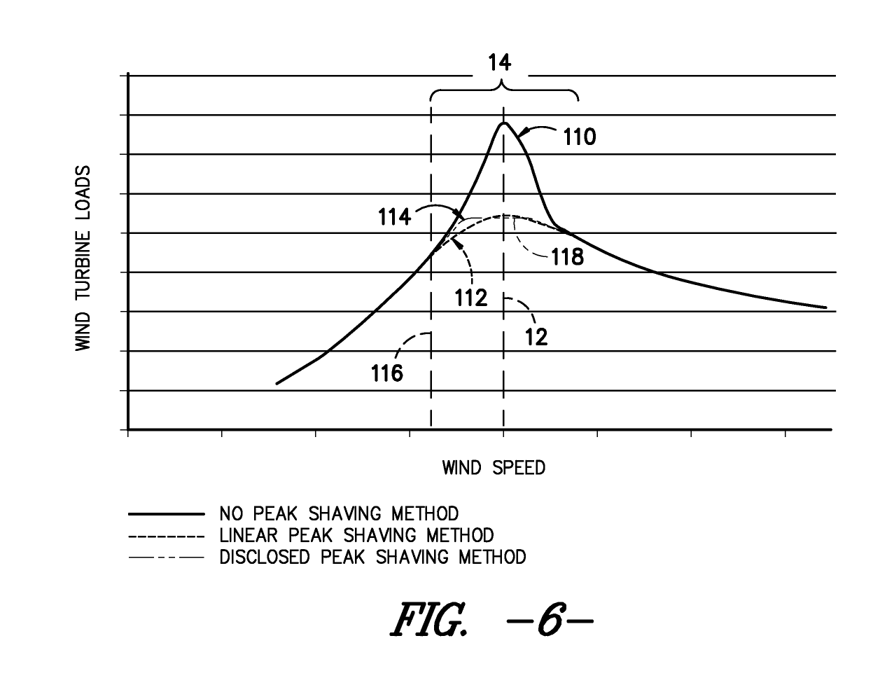

In several embodiments of the present subject matter, the wind turbine 20 may include one or more sensors 58, 60 configured to monitor a peak shaving parameter of the wind turbine 20. As used herein, the term “peak shaving parameter” refers to any operating parameter and/or condition of a wind turbine 20 that may be directly or indirectly related to the pitch angle of a rotor blade such that the peak shaving control method described below with reference to FIG. 5 may be performed. For example, in several embodiments, the peak shaving parameter may correspond to the power output of the wind turbine 20. Thus, in such embodiments, the wind turbine 20 may include one or more power output sensors 58 configured to monitor the power output of the wind turbine 20. For instance, the power output sensor(s) 58 may comprise sensors configured to monitor electrical properties of the output of the generator 34, such as current sensors, voltage sensors or power monitors that monitor power output directly based on current and voltage measurements. Alternatively, the power output sensors 58 may comprise any other sensors that may be utilized to monitor the power output of a wind turbine 20. For example, in one embodiment, the power output sensors 58 may comprise one or more strain gauges or torque sensors configured to monitor detect on the output shaft of the generator 34, which may then be correlated to the power output of the wind turbine 20.

In other embodiments, the peak shaving parameter may correspond to loads acting on the wind turbine 20. In such embodiments, the wind turbine 20 may include one or more load sensors 60 configured to monitor the loads acting on and/or through one or more of the components of the wind turbine 20. For example, the load sensors 60 may be configured to directly or indirectly measure thrust loads on one or more of the components of the wind turbine 20, such as by monitoring thrust loads on the rotor 28 by monitoring wind speed using an anemometer or any other suitable wind speed sensor. In addition, the load sensors 60 may be configured to directly or indirectly measure the moments acting on and/or through one or more of the components of the wind turbine 20 (e.g., by monitoring the bending moments acting on the tower and/or the blades and/or by monitoring the nodding moments acting on machine head), such as by using strain gauges, accelerometers, position sensors, optical sensors and/or the like to monitor the deflections of one or more wind turbine components caused by bending moments. For example, as shown in FIG. 3, one or more load sensors 60 may be mounted within the rotor blades 32 and/or the tower 14 to monitor any bending moments acting on such components. Of course, it should be appreciated that the load sensors 60 may comprise any other suitable sensors configured to monitor any other loads acting on the wind turbine 20.

It should also be appreciated that, in alternative embodiments, the peak shaving parameter may comprise any other suitable operating parameter and/or condition of a wind turbine 20 that may be directly or indirectly related to the target pitch angle required for peak shaving. In such embodiments, the wind turbine 20 may include any suitable sensors that permit such peak shaving parameter to be monitored. In addition, it should be appreciated that the peak shaving parameter may comprise a combination of operating parameters and/or conditions of a wind turbine 20, such as a combination of power output and loads.

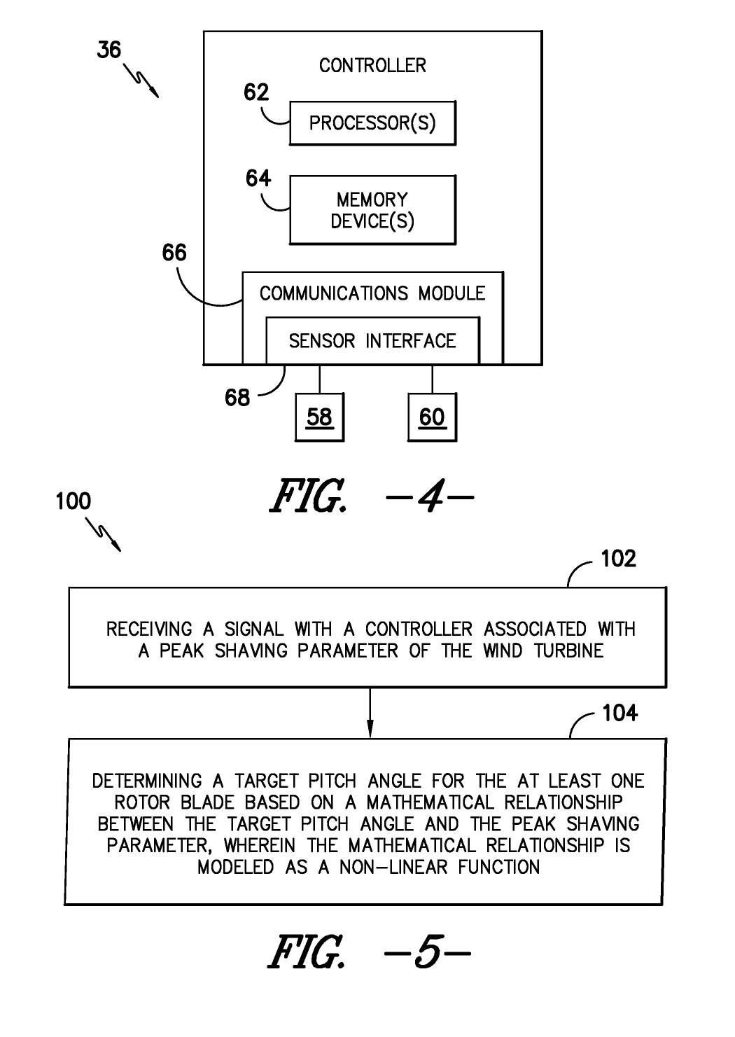

Referring now to FIG. 4, there is illustrated a block diagram of one embodiment of suitable components that may be included within the turbine controller 36 (or the pitch controller 40) in accordance with aspects of the present subject matter. As shown, the turbine controller 36 may include one or more processor(s) 62 and associated memory device(s) 64 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 64 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 64 may generally be configured to store suitable computer-readable instructions that, when implemented by the processor(s) 62, configure the turbine controller 36 to perform various functions including, but not limited to, directly or indirectly (via the pitch controller 40) transmitting suitable control signals to one or more of the pitch adjustment mechanisms 42, monitoring the peak shaving parameter(s) of the wind turbine 20, determining target pitch angles for the rotor blades 32 based on the peak shaving parameter(s) and various other suitable computer-implemented functions.

Additionally, the turbine controller 36 may also include a communications module 66 to facilitate communications between the controller 36 and the various components of the wind turbine 10. For instance, the communications module 66 may serve as an interface to permit the turbine controller 36 to transmit control signals to each pitch adjustment mechanism 42 for controlling the pitch angle of the rotor blades 32. Moreover, the communications module 66 may include a sensor interface 68 (e.g., one or more analog-to-digital converters) to permit signals transmitted from the sensors 58, 60 to be converted into signals that can be understood and processed by the processors 62.

Referring now to FIG. 5, there is illustrated one embodiment of a method 100 for determining the pitch angle for a rotor blade 32 during peak shaving. As shown, the method 100 generally includes receiving a signal with a controller associated with a peak shaving parameter of the wind turbine 102 and determining a target pitch angle for at least one rotor blade of the wind turbine based on a mathematical relationship between the target pitch angle and the peak shaving parameter, wherein the mathematical relationship is modeled as non-linear function 104.

Specifically, in 102, a signal may be received that is associated with a peak shaving parameter of the wind turbine 20. For example, as described above, the turbine controller 36 may be communicatively coupled to one or more sensors 58, 50 configured to monitor a peak shaving parameter of the wind turbine 20, such as the power output of the wind turbine 20 and/or the loads acting on the wind turbine 20. Thus, the turbine controller 36 may be configured to receive signals from such sensors 58, 60 associated with the peak shaving parameter. Alternatively, the turbine controller 36 may be provided with suitable computer readable instructions that, when implemented by its processor(s) 62, configure the turbine controller 36 to calculate and/or estimate one or more of the peak shaving parameters of the wind turbine 20 based on information stored within its memory 64 and/or based on other inputs received by the turbine controller 36.

Additionally, as shown in FIG. 5, in 104, a target pitch angle for one or more of the rotor blades 32 (i.e., the pitch angle to which a rotor blade is adjusted within the peak shaving range 14 (FIG. 1)) may be determined based on a mathematical relationship between the target pitch angle and the peak shaving parameter. As indicated above, conventional peak shaving methods rely on a linear relationship between pitch angle and power output in order to make pitch angle adjustments during within the peak shaving range 14. However, it has been determined that such linear peak shaving results in excess power losses. In this light, the inventors of the present subject matter have found that power losses resulting from the use of peak shaving control methods may be reduced by modeling the mathematical relationship as a non-linear function, such as a second order or higher polynomial function.

For example, in several embodiments, the relationship between the target pitch angle and the peak shaving parameter may be modeled as a second order polynomial function. Specifically, in one embodiment, the relationship may be modeled using the following quadratic equation:

y=Ax²+Bx+C

wherein y corresponds to the target pitch angle, x corresponds to the peak shaving parameter and A, B and C correspond to predetermined constants. However, in another embodiment, any other suitable second order polynomial function may be utilized to relate the peak shaving parameter to the target pitch angle.

Similarly, in various embodiments, the relationship between the target pitch angle and the peak shaving parameter may be modeled as a third order polynomial function. For instance, the relationship may be modeled using the following cubic equation:

y=Ax³+Bx²+Cx+D

wherein y corresponds to the target pitch angle, x corresponds to the peak shaving parameter and A, B, C and D correspond to predetermined constants. However, in an alternative embodiment, any other suitable third order polynomial function may be utilized to relate the peak shaving parameter to the target pitch angle.

It should be appreciated that, in further embodiments, the relationship between the target pitch angle and the peak shaving parameter may be modeled as a fourth order, fifth order or higher order polynomial function or as any other suitable non-linear function.

It should also be appreciated that the predetermined constants utilized with the polynomial functions described above may generally vary from wind turbine 20 to wind turbine 20 depending on numerous factors including but, not limited to, the size or configuration of a wind turbine 20, the operating conditions of a wind turbine 20 and/or various other design consideration for a wind turbine 20. Thus, in several embodiments, the predetermined constants may be determined on a case-by-case basis for each particular wind turbine 20 using any suitable method known in the art, such as by determining the predetermined constants for a particular wind turbine 20 experimentally, mathematically and/or using any other suitable design methodology. However, it is noted that the predetermined constants may generally be selected such that the loads acting on a wind turbine 20 within the peak shaving range 14 (FIG. 1) are reduced while maximizing the power output of the wind turbine 20. For example, the constants may be defined by curve fitting a line through a desired pitch angle vs. peak shaving parameter curve, which may be created through a system simulation of the wind turbine 20.

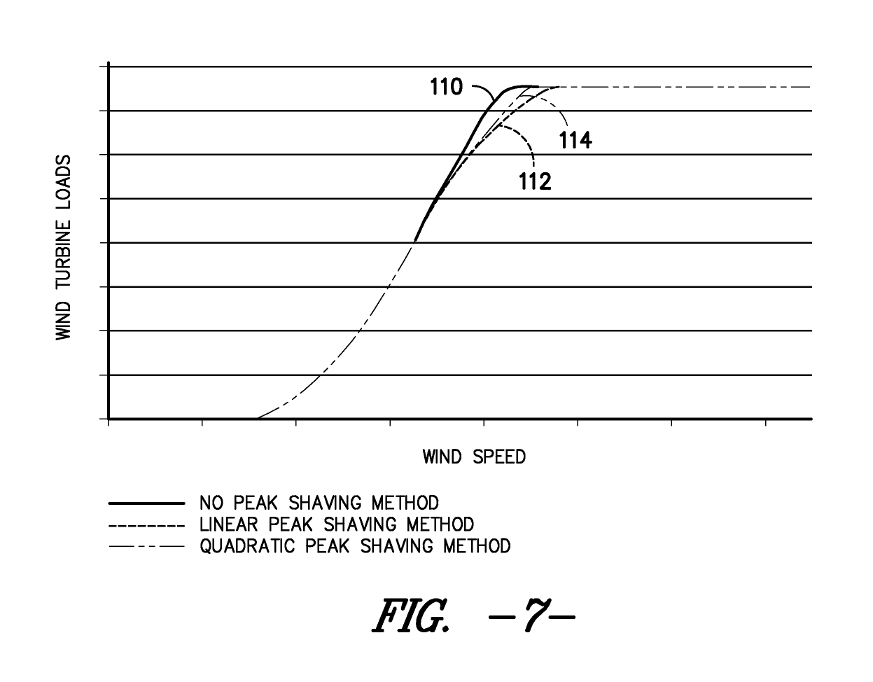

Referring now to FIGS. 6 and 7, graphs are provided for comparing the conventional linear peak shaving method to the disclosed peak shaving method 100. Specifically, FIG. 6 illustrates a graph of wind speed (x-axis) versus loads (y-axis) when no peak shaving method is used (indicated by line 110), when a linear peak shaving method is used (indicated by line 112) and when the disclosed peak shaving method 100 is used (indicated by line 114). Similarly, FIG. 7 illustrates a graph of wind speed (x-axis) versus power output (y-axis) when no peak shaving method is used (indicated by line 110), when a linear peak shaving method is used (indicated by line 112) and when the disclosed peak shaving method 100 is used (indicated by line 114). It should be appreciated that the data for lines 114 in FIGS. 6 and 7 is plotted using the quadratic equation described above in order to model the relationship between the target pitch angle and the peak shaving parameter. However, as indicated above, the disclosed method 100 need not be limited to a quadratic function, but may generally utilize any second or higher order function to relate the peak shaving parameter to the target pitch angle for purposes of performing peak shaving.

As shown in FIG. 6, using either methodology, the rotor blades 32 may begin to be pitched prior to the rated wind speed 12 at a predetermined peak shaving threshold 116. For example, in several embodiments, the predetermined peak shaving threshold 116 may correspond to a predetermined wind speed for the wind turbine 10, a predetermined load limit for the wind turbine 10, a predetermined power output value for the wind turbine 10 and/or any other threshold at which it is determined that pitching of the rotor blades 32 may be necessary in order to reduce loading on the wind turbine 20.

As indicated above, the rate of change in which loading on a wind turbine 20 may be adjusted is relatively slow using a conventional linear peak shaving method. Thus, as shown in FIG. 6, line 112 defines a rounded-off, curved section 16 extending from the peak shaving threshold 116 and into the peak shaving range 14. However, by modeling the relationship between the target pitch angle and the peak shaving parameter using a non-linear function (e.g., a second order polynomial function), adjustments to the loads acting on a wind turbine 20 may be performed more rapidly. Specifically, as shown in FIG. 6, the pitch angle of the rotor blades 32 may be controlled such that loading on the wind turbine 20 is changed abruptly after the peak shaving threshold 116 (i.e., from increasing loads to generally constant loads), thereby resulting in a flattened section 118 defined along line 114 within the peak shaving range 14. This ability to make such abrupt changes allows for line 114 to closely track line 110 at the edges of the peak shaving range 14, thereby minimizing the overall impact of peak sheaving.

For example, as shown in FIG. 7, by providing the ability to more quickly adjust the loads acting on a wind turbine 20, the power output that may be achieved using the disclosed method 100 is higher than the power output that may achieved using the conventional linear peak shaving method (indicated by the gap between lines 112 and 114). Specifically, the present inventors have determined that, in some embodiments, an increase in AEP of about 0.75% may be obtained using the disclosed method 100 for peak shaving as opposed to the conventional linear peak shaving method. However, it is also believed that increases in AEP of greater than about 0.75% may also be achieved using the disclosed method 100.

As indicated above, it should be appreciated that, in several embodiments, the disclosed method 100 may be implemented automatically using the turbine controller 36 or any other suitable processing unit. For example, the rotor blades 32 may be maintained in the power position until the predetermined peak shaving threshold 116 is reached. However, once the predetermined peak shaving threshold 116 is reached, the turbine controller 36 may automatically adjust the pitch angle of the rotor blades 32, such as by directly or indirectly (via the pitch controller(s) 40) transmitting control signals to the pitch adjustment mechanisms 42, based on the peak shaving parameter(s) of the wind turbine 20. For instance, as described above, in one embodiment, a quadratic or cubic equation relating the target pitch angle to the peak shaving parameter may be stored within the memory of the controller 36. In such an embodiment, the controller 36 may be configured to automatically determine the peak shaving parameter (e.g., by analyzing measurement signals from the sensors 58, 60 described above) and then calculate the target pitch angle for each rotor blade 32 by inputting the peak shaving parameter into the stored equation. The calculated pitch angles may then be used as the basis for adjusting the actual pitch angles of the rotor blades during peak shaving.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for determining pitch angles for at least one rotor blade of a wind turbine during peak shaving, the method comprising:
receiving a signal with a controller associated with a peak shaving parameter of the wind turbine; and
determining a target pitch angle for the at least one rotor blade based on a mathematical relationship between the target pitch angle and the peak shaving parameter,
wherein the mathematical relationship is modeled as a non-linear function.

2. The method of claim 1, wherein receiving a signal with a controller associated with a peak shaving parameter of the wind turbine comprises receiving a signal from a sensor associated with a power output of the wind turbine.

3. The method of claim 1, wherein receiving a signal with a controller associated with a peak shaving parameter of the wind turbine comprises receiving a signal from a sensor associated with a load acting on the wind turbine.

4. The method of claim 3, wherein the load acting on the wind turbine comprise at least one of a thrust load or a moment.

5. The method of claim 1, wherein the mathematical relationship is modeled using a quadratic equation.

6. The method of claim 1, wherein the mathematical relationship is modeled using a cubic equation.

7. The method of claim 1, further comprising adjusting a pitch angle of the at least one rotor blade based on the target pitch angle.

8. The method of claim 7, wherein adjusting a pitch angle of the at least one rotor blade based on the target pitch angle comprises controlling the pitch angle with a pitch adjustment mechanism of the wind turbine.

9. The method of claim 7, wherein adjusting an pitch angle of the at least one rotor blade based on the target pitch angle comprises adjusting the pitch angle based on the target pitch angle after a predetermined peak shaving threshold is reached.

10. The method of claim 9, wherein the predetermined peak shaving threshold is based on at least one of a predetermined load limit for the wind turbine or a predetermined wind speed for the wind turbine.

11. A system for determining pitch angles for at least one rotor blade of a wind turbine during peak shaving, the system comprising:
a sensor configured to monitor a peak shaving parameter of the wind turbine; and
a controller communicatively coupled to the sensor, the controller being configured to determine a target pitch angle for the at least one rotor blade based on a mathematical relationship between the target pitch angle and the peak shaving parameter,
wherein the mathematical relationship is modeled as a non-linear function.

12. The system of claim 11, wherein the peak shaving parameter comprises a power output of the wind turbine.

13. The system of claim 11, wherein the peak shaving parameter comprises a load acting on the wind turbine.

14. The system of claim 11, wherein the load comprises at least one of a thrust load or a moment.

15. The system of claim 11, wherein the mathematical relationship is modeled using a quadratic equation.

16. The system of claim 11, wherein the mathematical relationship is modeled using a cubic equation.

17. The system of claim 11, further comprising a pitch adjustment mechanism communicatively coupled to the controller, the pitch adjustment mechanism being configured to adjust a pitch angle of the at least one rotor blade.

18. The system of claim 17, wherein the controller is further configured to control operation of the pitch adjustment mechanism such that the pitch angle is adjusted by the pitch adjustment mechanism based on the target pitch angle when a predetermined peak shaving threshold is reached.

19. The system of claim 18, wherein the predetermined peak shaving threshold is based on at least one of a predetermined load limit for the wind turbine or a predetermined wind speed for the wind turbine.

20. The system of claim 11, wherein the controller comprises a turbine controller of the wind turbine.
